(19) United States
(12) Patent Application Publication
(10) Pub. No.: US 2015/0102129 A1
(43) Pub. Date: Apr. 16, 2015

(54) MOUNTING ASSEMBLY

(71) Applicant: Reaction Engines Ltd, Abingdon (GB)

(72) Inventors: Alan Bond, Abingdon (GB); Richard Varvill, Abingdon (GB)

(21) Appl. No.: 14/296,618

(22) Filed: Jun. 5, 2014

(30) Foreign Application Priority Data
Oct. 11, 2013 (GB) 1318105.2
Oct. 11, 2013 (GB) 1318110.2

(51) Int. Cl. F02K 9/84; F16L 27/10

(52) U.S. Cl. CPC F02K 9/84; F16L 27/10
USPC 239/265.35; 285/184; 137/343

(57) ABSTRACT

The invention relates to a mounting assembly for a rocket nozzle for an engine that may be operable in rocket mode, in which the engine combusts stored oxygen and hydrogen, or in air-breathing mode, in which the engine combusts air from the atmosphere and stored hydrogen. A plurality of ducts and pipes are connected to the nozzle to supply fuel and other fluids. As it is desirable to allow the nozzle to pivot, the mounting assembly may include flexible couplings on the ducts and pipes about selected pivot points allowing the desired freedom of motion. The flexible couplings are designed to withstand various pressure forces in the rocket/aircraft flight environment, and may be composed of spaced annular elements, wherein a partial toroid element connects consecutive pairs of annular elements.

### CROSS-REFERENCE TO RELATED APPLICATIONS

The present application claims priority under 35 U.S.C. §119(a) to the following applications filed in the United Kingdom on Oct. 11, 2013, each of which is incorporated herein by reference: GB 1318105.2 and GB 1318110.2.

### FIELD

The present disclosure relates to a mounting assembly for a rocket nozzle for facilitating the control of a rocket trajectory for example in a single stage to orbit (SSTO) vehicle. The present disclosure also relates to a flexible coupling for use in such a mounting assembly. The disclosure also relates to an aircraft or aerospace vehicle including such a mounting assembly.

### BACKGROUND

Typically in a rocket engine, a plurality of fluid ducts or pipes are provided in order to supply fuel and air or other oxidant to the rocket combustion chamber. However, with a large number of ducts or connections, the maneuverability of a rocket nozzle associated with the rocket combustion chamber can be hindered.

The present disclosure seeks to alleviate, at least to a certain degree, the problems and/or address at least to a certain extent, the difficulties associated with the prior art.

### SUMMARY

According to a first aspect of the disclosure, there is provided a mounting assembly for mounting a rocket nozzle to allow the nozzle to pivot about a pivot or gimbal point, the assembly comprising a fluid duct for supply of fluid to said nozzle, the duct comprising two or more flexible fluid couplings which substantially intersect a common plane on which said pivot point is arranged.

Such a mounting can advantageously provide a compact fluid coupling arrangement. The fluid ducts may be formed of substantially rigid ducts to withstand high pressure gases flowing within the ducts. The flexible couplings can be relatively short in length compared with the length of the ducts, minimizing sections of reduced rigidity. The arrangement of the flexible couplings intersecting a common plane can facilitate movement relative to the plane in a direction traverse to the plane, parallel to the plane or in rotation about the gimbal or pivot point in the plane. The flexible fluid couplings may be used to couple consecutive sections of the fluid duct to supply fluids, for example to a combustion chamber attached to or associated with said nozzle.

The flexible couplings may intersect the common plane by being arranged substantially on or orientated in line with or crossing or traversing the common plane. The flexible couplings may traverse the common plane orthogonally to the surface of the common plane.

Optionally, the mounting assembly is configured as a rocket nozzle mounting assembly. Optionally, the mounting assembly may be used for non-rocket applications, where fluid couplings are provided to a pivoting body or element.

The arrangement of the flexible couplings relative to the common plane herein described are generally when the nozzles are at rest, i.e. the longitudinal and/or rotational axis of the nozzle is aligned with a gimbal axis which is perpendicular to the gimbal plane and passes through the gimbal point.

In this description, reference to a flexible coupling is also intended to cover reference to a portion of a flexible coupling.

The fluid ducts may be formed of substantially rigid materials. The ducts may be formed as pipes or channels of generally circular cross-section. The ducts may be formed of metals, for example nickel, titanium or alloys, composite materials or any other suitable material.

Optionally, the fluid duct includes portions on either side of the gimbal point on the common plane.

The flexible couplings may be formed with a generally circular cross-section. The flexible couplings may be coupled to fluid ducts using welding or other joining techniques.

The internal flow passages or longitudinal axes of the flexible couplings, optionally when unflexed, may optionally be aligned in or with the common plane, or perpendicular thereto or at least in sections or parts of the flexible couplings which traverse the common plane.

The duct between a consecutive pair or pairs of flexible couplings is optionally rigid or substantially rigid, at least relative to the flexible coupling. The ducts may comprise straight sections and/or curved sections.

Optionally, a consecutive pair or pairs of said flexible fluid couplings of a fluid duct or sections of the flexible couplings which traverse the common plane, are arranged generally orthogonal to one another about a central axis passing through said pivot point. The duct between a consecutive pair of flexible couplings may be aligned in or parallel to the common plane.

The flexible couplings may comprise of or be formed as relatively short sections relative to the duct lengths. The flexible couplings may be arranged or configured to prevent strain being imparted by the pivoting to fluid ducts coupled to said flexible couplings.

The flexible couplings may be aligned with their flow passages in line or in plane with the common plane or perpendicular to or traversing the common plane. The flexible couplings may be configured such that they are unflexed or undeformed when the thrust trajectory of the nozzle is perpendicular to the common plane.

Additional ducts may also be provided with two or three or more flexible couplings. The flexible couplings of the additional ducts may be spaced or offset from the common plane.

Optionally, said mounting assembly comprises a further fluid duct comprising a flexible fluid coupling arranged on or traversing said common plane and in line with said pivot point or in line with a gimbal axis which passes through said pivot point and relative to which the rocket nozzle may be angled.

Optionally, said flexible couplings are configured as bellow-like couplings. The flexible couplings may be provided with an external or internal gimbal arrangement. The internal gimbal arrangement may be coupled to the flexible coupling via internal vanes.

Optionally, said mounting assembly further comprises a mounting for a rocket nozzle, the mounting being gimbaled or pivotally coupled to allow rotation of the mounting about orthogonal axes on said common plane.

The mounting may comprise pairs of rotational pivots arranged as a gimbal for multi-directional movement of the nozzle about the gimbal point.

The mounting may be configured to permit angular adjustment of the nozzle by up to −/+5 degrees or up to +/−3 degrees.

Optionally, said mounting assembly further comprises one or more actuators for effecting rotation of the mounting about said orthogonal axes. The actuators may comprise hydraulic, electric or electrohydraulic actuators.

Optionally, said mounting assembly further comprises a rocket nozzle supported on said mounting, the rocket nozzle having its central longitudinal axis substantially concentric with said pivot point. At rest, the longitudinal axis of the nozzle may be aligned with the gimbal axis which passes through said gimbal point. The rocket nozzle may be supported along with an associated rocket combustion chamber or combustion chamber arrangement.

According to a second aspect of the disclosure, there is provided a rocket engine module comprising a plurality of mounting assemblies according to the first aspect of the disclosure with or without any optional feature thereof.

The mounting assemblies may be symmetrically arranged. Four mounting assemblies may be provided. The rocket engine module may comprise an air breathing rocket and/or a hybrid air-breathing, liquid oxygen rocket.

The rocket engine module may comprise an air breathing rocket combustion chamber and an air-breathing combustion chamber. The duct and flexible coupling arrangement can assist with packaging requirements with such a module.

The rocket engine module may comprise a turbo-compressor for the compression of air and a heat exchanger for cooling said compressed air.

According to a third aspect of the disclosure, there is provided a flexible coupling, comprising a plurality of spaced annular elements, wherein connecting consecutive pairs of annular elements, a partial toroid element is provided.

Optionally, the annular elements are formed as annular rings. Optionally, the annular elements are formed of round or rounded section wire, for example wire with a substantially square cross-section with rounded corners/edges, or a wire with an oval cross section.

Optionally, the annular elements are provided as a spiral wall element.

Optionally, each partial toroid element is part of a single sheet of material.

Optionally, the wall thickness of said annular elements is greater than the wall thickness of said partial toroid element.

Optionally, the coupling is formed of a metallic material. The coupling may be formed of nickel, titanium or any suitable alloy.

Optionally, the coupling comprises fiber reinforcement.

According to a fourth aspect of the disclosure, there is provided a mounting assembly for mounting a rocket nozzle to allow the nozzle to pivot about a pivot or gimbal point, the assembly comprising a fluid duct for supply of fluid to said nozzle, the duct comprising a flexible fluid coupling arranged on the pivot point and/or traversing a common plane in line with said pivot point. Optionally, the flexible coupling is in line with a gimbal axis which passes through said gimbal point and relative to which the rocket nozzle can be angled.

According to a fifth aspect of the disclosure, there is provided a vehicle, an aircraft or aerospace vehicle comprising a mounting assembly according to the first or fourth aspect, and/or a rocket engine module according to the second aspect and/or a flexible coupling according to the third aspect with or without any optional feature thereof.

### BRIEF DESCRIPTION OF THE DRAWINGS

The present disclosure may be carried out in various ways and embodiments of the disclosure will now be described by way of example with reference to the accompanying drawings, in which:

FIGS. 1A, 1B and 1C show side, plan and rear elevations respectively of a single stage to orbit (SSTO) aircraft;

FIG. 2 shows a cross-section through a nacelle containing a rocket engine

FIG. 3a shows a schematic side view of a rocket nozzle with a flexible coupling provided concentric with the axis of the nozzle;

FIG. 3b shows an end on view of the arrangement shown in FIG. 3a;

FIG. 4a shows a schematic side view of a rocket nozzle with a fluid conduit provided with two flexible couplings;

FIG. 4b shows an end on view of the arrangement shown in FIG. 4a;

FIG. 5a shows a schematic side view of a rocket nozzle with a fluid conduit with three flexible couplings;

FIG. 5b shows an end on view of the arrangement shown in FIG. 5a;

FIG. 6a shows a schematic end of a rocket nozzle with a fluid conduit with two flexible couplings;

FIG. 6b shows a side view of the arrangement as shown in FIG. 6a;

FIG. 7a shows a schematic end of a rocket nozzle with a fluid conduit with two flexible couplings;

FIG. 7b shows a side view of the arrangement as shown in FIG. 7a;

FIG. 8a shows a further example of a rocket engine module comprising two types of combustion chamber;

FIG. 8b shows a view in the longitudinal direction of the rocket nozzle outlet of FIG. 8a;

FIG. 9 shows a cross-section through a flexible fluid coupling;

FIG. 10 shows a partial cross-section through an alternative flexible fluid coupling;

FIG. 11a shows a schematic view an actuator arrangement for controlling the angle of a rocket nozzle; and

FIG. 11b shows a plan view in the direction of the nozzle outlet of FIG. 11a.

### DETAILED DESCRIPTION

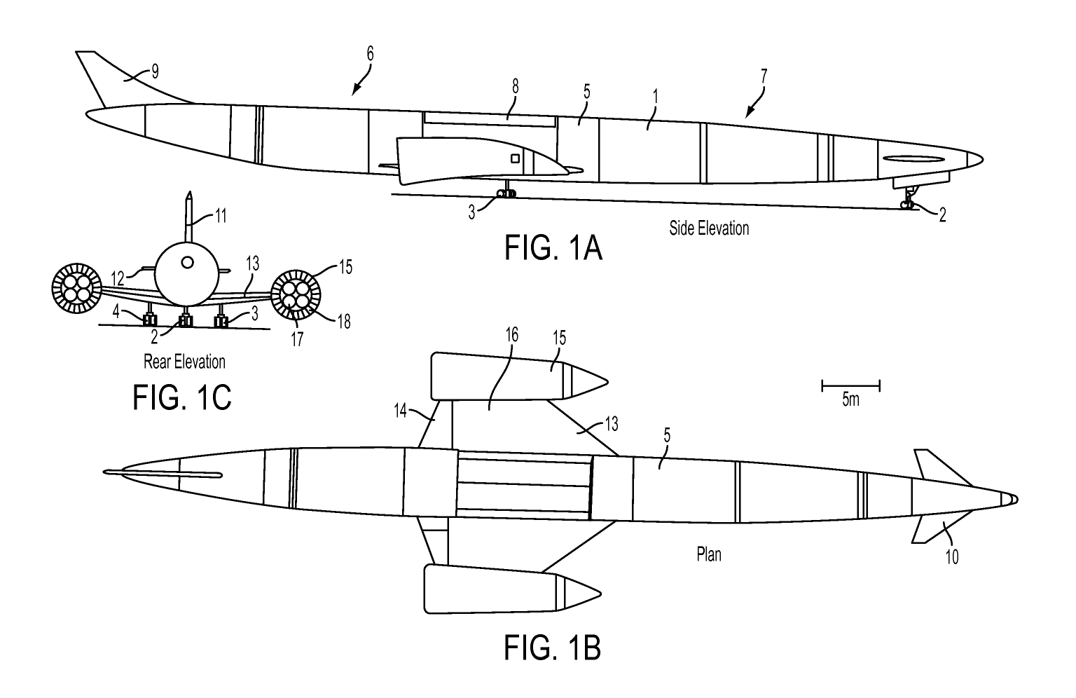

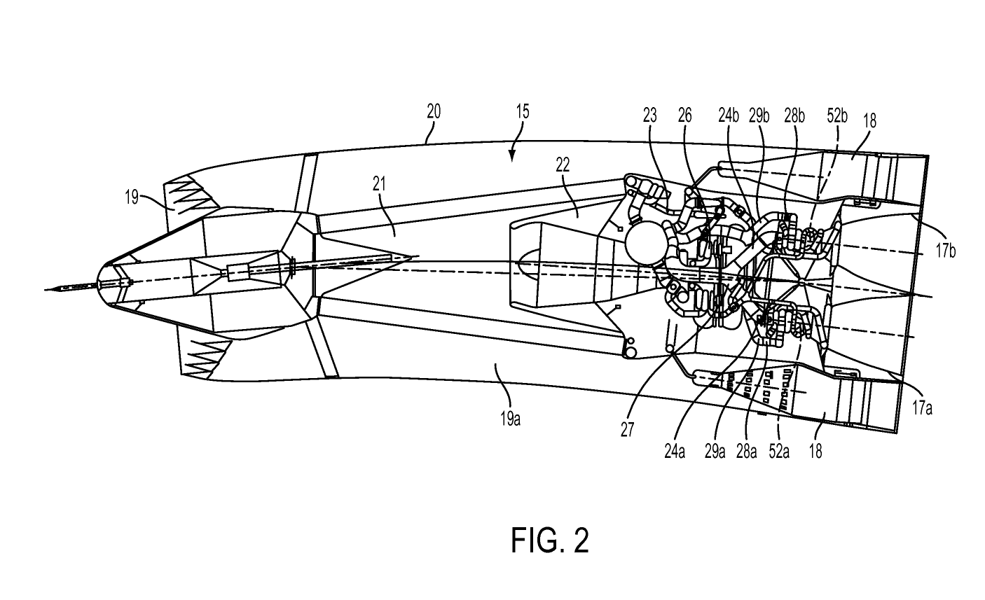

FIGS. 1A, 1B, and 1C show a single stage to orbit (SSTO) aircraft 1 with a retractable undercarriage 2, 3, 4, having a fuselage 5 with fuel and oxidant stores 6, 7 and a payload region 8. A tail fin arrangement 9 and canard arrangement 10 are attached to the fuselage 5. Main wings 13 with ailerons 14 are attached to either side of the fuselage 5 and each wing 13 has an engine module 15 attached to a wing tip 16 thereof. As shown in FIGS. 1C and 2, the rear of each engine module 15 is provided with four rocket nozzles 17 surrounded by various bypass burners 18.

FIG. 2 shows an engine module contained within a nacelle 20, which may be attached to an aircraft wing, such as an aircraft wing 13 of an aircraft 1 as shown in FIGS. 1A, 1B and 1C.

The engine module 15 includes air inlet 19, heat exchanger 21, turbo-compressor 22 and a plurality of fluid flow conduits or channels 23 for the supply of fluid, such as fuel/oxidant to combustion chambers associated with rocket nozzles 17a, 17b.

During operation of the engine module 15, part of the incoming air passing through the air inlet 19 passes through the heat exchanger 21 to the turbo compressor 22 and another part is bypassed along bypass duct 19a to the bypass burners 18. These bypass burners 18 can provide additional thrust to the thrust provided through the main rocket nozzles 17.

The rocket nozzles 17a, 17b may provide thrust through the combustion of fuel with an oxidant in a rocket combustion chamber 52a, 52b associated with each nozzle 17a, 17b. The fuel may, for example, be hydrogen fuel. The oxidant may comprise air which has passed through the turbo-compressor 22 and/or may comprise liquid oxygen from an on-board liquid oxygen store.

It will be understood that the engine module may be replaced with other types of engine module and that the mounting arrangement described in this disclosure may be equally applied to different engine configurations.

In the engine module as shown in schematic cross-section in FIG. 2, air passes from the turbo compressor 22 through a central main air flow duct 27 which splits into divergent ducts 24a, 24b to deliver air to combustion chambers 52a, 52b associated with each of the rocket nozzles 17a, 17b. Although only two rocket nozzles 17a, 17b are shown in FIG. 2, it should be understood that any number of rocket nozzles may be chosen depending on the thrust required and the packaging constraints of the vehicle.

Each of the divergent air ducts 24a, 24b diverge at an angle to a center line passing through the main inlet air duct 27. The ducts 24a, 24b extend partially radially and partially axially with the distal end of each duct (i.e. the end furthest from the main air flow duct 27) in alignment with the central rotational axis of a respective rocket nozzle 17a, 17b.

The air ducts 24a, 24b are coupled to the combustion chamber 52a, 52b of the respective rocket nozzle 17a, 17b.

Fuel is delivered to the rocket chambers 52a, 52b of the nozzles 17a, 17b via ducts 29a, 29b using pump 26.

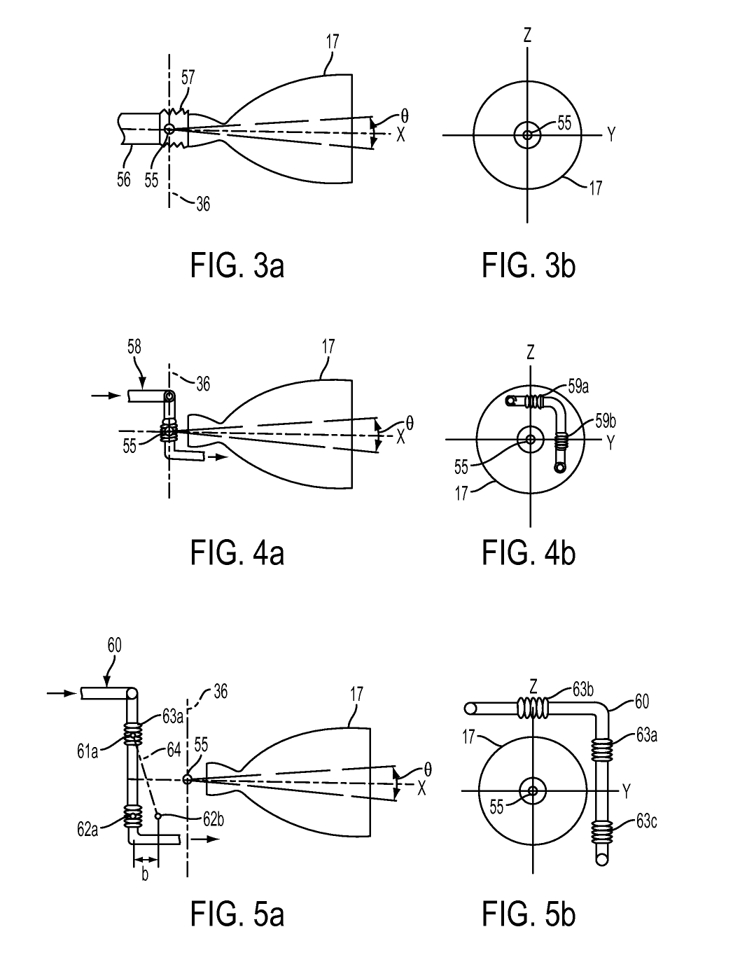

The ducts shown in FIG. 2 may be coupled to the rocket combustion chambers or nozzles using one or more of the coupling arrangements shown in FIGS. 3a to 7b and described below.

FIG. 3a shows a side view of a rocket nozzle 17, which is gimbaled about a pivot or gimbal point 55. The pivot or gimbal 55 may permit pivoting or rotation of the nozzle about one or more axes. In the embodiment, the nozzle may pivot about two orthogonal axes z, y.

The degree of movement permitted will depend on application. In the embodiment, the degree of movement or pivoting angle, θ, may be of the order +/−3 degrees relative to the gimbal axis x. Each nozzle may be provided on a mounting which allows for the pivoting or gimballing of each nozzle.

The orientation of each nozzle may be adjusted in order to control the trajectory of the aircraft to which the engine module is attached. Actuators (not shown) may be provided in order to control the degree of movement of the nozzles.

In the embodiment, the rocket combustion chamber/nozzle 17 is supplied with air or other fluid via duct 56. A flexible coupling 57 is provided to couple the duct 56 to the combustion chamber/nozzle arrangement 17. The flexible coupling 57 intersects a common or gimbal plane 36, by crossing or traversing said gimbal plane 36, which is a plane passing through the pivot or gimbal point 55 and perpendicular to gimbal axis x relative to which the nozzle can be angled.

The flexible coupling 57 is arranged concentric on the gimbal axis x at the point the coupling traverses the gimbal plane. The gimbal axis is an axis passing through the gimbal point and perpendicular to the gimbal plane 36.

The flexible coupling 57 provides a compliant coupling to permit pivoting of the nozzle/combustion chamber assembly 17 about the pivot point 55. With such an arrangement with the coupling 57 on the gimbal axis, x, only a single flexible coupling 57 is required. The flexible coupling may be a bellow type connection.

The arrangement as shown in FIG. 3a, 3b has the advantage that the axial thrust load on the gimbal 55 is reduced as it is offset by the axial air or fluid pressure load in the flexible coupling 57. In addition, the arrangement is also more compact than the arrangements shown in 4a, 4b, 5a, 5b and is therefore most suited to the largest diameter pipe crossing the gimbal plane.

FIG. 4a shows a side view of a rocket combustion chamber/nozzle assembly 17 which is supplied with fluid from duct 58. The duct 58 may, for example, supply cooling medium to the rocket nozzle skirt. The duct 58 may be provided in additional to the duct 56 shown in FIG. 3a, for example where multiple fluid connections to the rocket nozzle/chamber are required.

As shown in FIG. 4b, the duct 58 is provided with two flexible couplings 59a, 59b which intersect the gimbal plane by being aligned in the gimbal plane 36. The two flexible couplings 59a, 59b or at least a portion thereof are positioned or arranged orthogonal to one another about the gimbal point 55.

The flexible couplings 59a, 59b are arranged substantially in alignment on the common plane 36, which, when the nozzles 17 are at rest, i.e. with no pivoting, is perpendicular to the gimbal axis, x. In the embodiment, the gimbal axis, x, is also the longitudinal rotational axis of the rocket nozzle 17, when the nozzle is at rest.

By providing each of the fluid ducts with a flexible coupling substantially intersecting, in the embodiment, by being aligned on or traversing the common plane 36, any possible strain imparted on the fluid supply ducts 24a, 24b, 28a, 28b as the nozzles pivot can be better controlled or reduced.

FIG. 5a shows how ducts can be coupled to the combustion chamber/rocket nozzle assembly 17 if the flexible couplings cannot be provided on the gimbal plane 36. Here, the duct 60 comprises three flexible couplings 63a, 63b, 63c as shown in FIG. 5b. The flexible couplings 63a, 63b, 63c are offset from the gimbal plane 36. The duct 60 can cope with fore/aft movement, b, of the duct pipe work. The ghost line 64 shows the movement of the duct 60, such that flexible coupling 63c is offset to position 62b at a distance, b, from its original position 62a, while flexible coupling 63a remains substantially in its original position 61a.

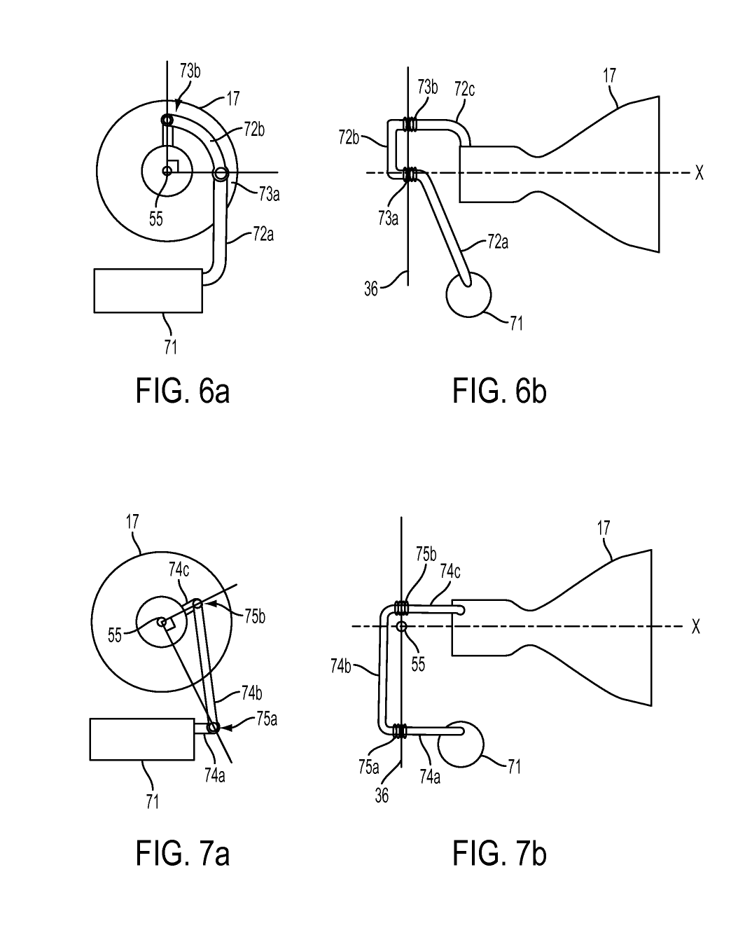

FIG. 6a shows an end view of a rocket combustion chamber/nozzle assembly 17 which is supplied with fluid from a propellant source represented by cylinder 71.

The fluid is supplied via a duct comprising three sections 72a, 72b, 72c. Between the first section 72a and the second section 72b of the duct, a flexible coupling 73a is provided. Between the second section 72b and the third section 72c of the duct, a further flexible coupling 73b is provided. The duct sections are substantially rigid.

As shown in FIG. 6a, the flexible couplings or at least a portion thereof are arranged or positioned orthogonal to one another about a gimbal point 55 which is in alignment with the central longitudinal axis X of the rocket nozzle. The second section 72b of duct follows a curve with its center of curvature on the gimbal point 55. In the embodiment, the flexible couplings 73a, 73b are arranged offset and substantially equidistant from the gimbal axis x in directions perpendicular therefrom.

As shown in FIG. 6b, the first and the second flexible couplings 73a, 73b are aligned so as to intersect the plane 36 by crossing or traversing the gimbal plane 36. The propellant source, in the embodiment, is arranged offset from the gimbal plane 36 in the direction of the open end of the nozzle 17.

The flexible couplings 73a, 73b are arranged crossing or traversing the common plane 36, which, when the nozzle 17 is at rest, i.e. with no pivoting, is perpendicular to the gimbal axis, x. In the embodiment, the gimbal axis, x, is also the longitudinal rotational axis of the rocket nozzle 17.

By providing the fluid duct with flexible couplings substantially aligned on or traversing the common plane 36, any possible strain imparted on the fluid supply ducts 72a, 72b, 72c as the nozzles pivot can be better controlled or reduced.

FIG. 7a shows an end view of a rocket combustion chamber/nozzle assembly 17 which is supplied with fluid from a propellant source represented by cylinder 71.

The fluid is supplied via a duct comprising three sections 74a, 74b, 74c. Between the first section 74a and the second section 74b of the duct, a flexible coupling 75a is provided. Between the second section 74b and the third section 74c of the duct, a further flexible coupling 75b is provided.

As shown in FIG. 7a, the flexible couplings or at least a portion thereof are arranged or positioned orthogonal to one another about a gimbal point 55 which is in alignment with the central longitudinal axis X of the rocket nozzle. The second section 74b of the duct has a main straight section arranged substantially parallel to the gimbal plane 36 and slopes or leans towards the gimbal axis X away from the propellant source 71. The first and second flexible couplings are thus arranged at different distances from the gimbal point 55 or axis X.

As shown in FIG. 7b, the first and the second flexible couplings 75a, 75b are aligned so as to cross or traverse the gimbal plane 36. The propellant source, in the embodiment, is arranged offset from the gimbal plane 36 in the direction of the open end of the nozzle 17.

The flexible couplings 75a, 75b are arranged substantially to cross or traverse the gimbal plane 36, which, when the nozzle 17 is at rest, i.e. with no pivoting, is perpendicular to the gimbal axis, x. In the embodiment, the gimbal axis, x, is also the longitudinal rotational axis of the rocket nozzle 17.

By providing the fluid duct with flexible couplings substantially aligned on or traversing the common plane 36, any possible strain imparted on the fluid supply ducts 74a, 74b, 74c as the nozzles pivot can be better controlled or reduced.

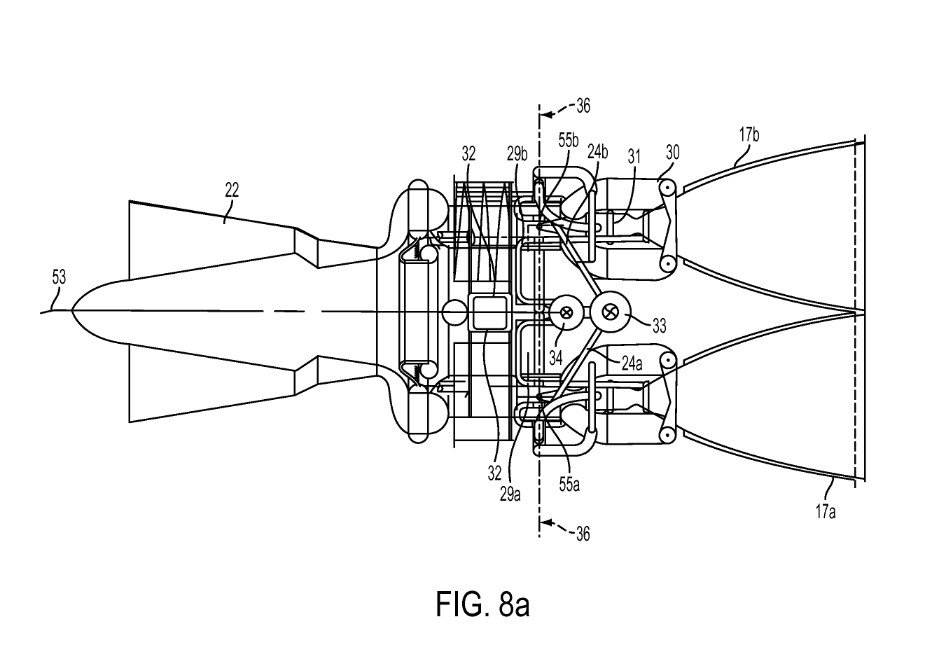

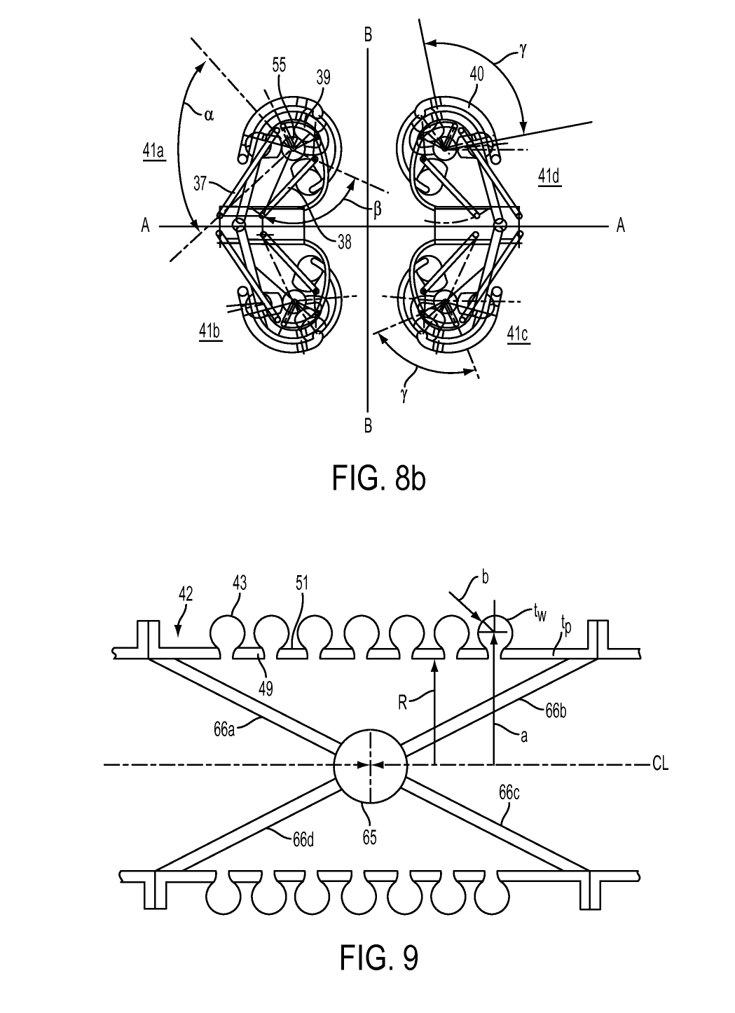

FIG. 8a shows in schematic cross-section, a possible implementation of the arrangements shown in FIGS. 3a through 5b in an aircraft rocket engine. The rocket engine as shown in FIG. 8a includes four rocket nozzles of which only two rocket nozzles 17a, 17b are shown. Associated with each of the rocket nozzles 17a, 17b are two types of combustion chamber for the combustion of oxidant and fuel. In the embodiment, the two types of combustion chamber are an air-breathing combustion chamber and a rocket combustion chamber. Three air-breathing combustion chambers 30 may be provided around a central rocket combustion chamber 31 with both the rocket combustion chamber and the air breathing combustions chambers sharing a common nozzle.

A liquid oxygen pump 33 is provided to supply oxidant to the rocket combustion chambers 30, 31 along fluid ducts 24a, 24b. A liquid hydrogen pump 34 is also provided to supply fuel to the rocket combustion chambers along fluid ducts 29a, 29b. A plurality of fuel or oxidant ducts may be provided to deliver fuel to required stages or sections of each combustion chamber.

The rocket engine includes a turbo compressor 22 for supplying compressed cooled air to the rocket combustion chambers.

The rocket combustion chambers and nozzles 17a, 17b are coupled indirectly to a box beam 32 which is connected to the aircraft in order to transfer thrust to the aircraft space frame. A triangulated spaceframe could also be used or any other suitable connection to aircraft.

The nozzles 17a, 17b are mounted on a mounting which allows them to pivot or gimbal relative to a common plane 36 about pivot or gimbal points 55a, 55b.

The rocket combustion chambers 30 may be fluidly coupled using the arrangements as shown in FIG. 3a with a single flexible coupling which traverses the gimbal plane 36. The common gimbal plane 36 is perpendicular to a longitudinal axis 53. At rest when the nozzles are not pivoted, the rotational axes of the rocket nozzles 17a, 17b are parallel to the longitudinal axis 53.

To supply fluids to the air-breathing combustion chambers 31, the duct and flexible coupling arrangement as shown in FIGS. 4a to 7b may be provided.

In the example, the fluid ducts are typically rigid, with the flexible couplings providing a compliant join between consecutive sections of fluid duct.

Each rocket nozzle and chamber may be supported on a mounting which can be pivoted or gimbaled to adjust the relative angle of nozzle relative to the gimbal plane 36 in order to adjust/control the trajectory of the aircraft. The maximum relative angle will depend on the particular engine and nozzle arrangement, but could typically be around +/−3 degrees to an axis perpendicular to the common gimbal plane.

By providing the supply ducts with flexible coupling arrangements as shown in FIGS. 3a to 7b, each rocket nozzle may rotate about a respective gimbal point on the gimbal plane 36.

FIG. 8b shows a plan view of the rocket nozzles as shown in FIG. 8a. As shown in FIG. 8b, the engine comprises four rocket engines each with a mounting arrangement 41a, 41b, 41c, 41b. The rocket engines are arranged symmetric about planes AA and BB. Although only one of these rocket nozzles will be described, each rocket nozzle is provided with similar fluid connections in the form of ducts 37, 38, 39 and 40. As described above, some of the ducts comprise flexible couplings which intersect a common plane, for example by being aligned in or traversing a common gimbal plane 36 as shown in FIG. 8a. In the example, a total of seven such ducts are provided to each combustion chamber/nozzle arrangement.

As viewed in FIG. 8b, some of the ducts are provided in line with or traversing the gimbal plane (plane 36 as shown in FIG. 8a). Such ducts are provided with pairs or orthogonally arranged or positioned flexible couplings (or parts thereof). The orthogonal angles between the pairs of flexible couplings are represented by angles alpha, beta, gamma and delta in four of these ducts. Typically, each duct is provided with two flexible couplings in alignment with the common gimbal plane 36.

In the example of FIG. 8b, each rocket nozzle 17a, 17b is provided with an oxidant carrying duct, which is provided in alignment with the gimbal point 55 or axis itself. In the example, for this central air duct, a single flexible coupling is provided which traverses the common gimbal plane 36.

The arrangement of flexible couplings which intersect the gimbal plane, for example by alignment with or traversing the gimbal plane 36, which is orthogonal to the gimbal point, can serve to allow a more compact arrangement and facilitate rocket nozzle movement control.

FIG. 9 shows a cross-section of a flexible coupling in the form of a bellows-like connection 42. The cross section comprises a plurality of spaced annular sections 51 or rings of radius R. Consecutive or successive pairs of annular sections 51 are joined via split or partial toroid sections 43 which extend radially from the edges of the annular sections 49, 51 with the toroid center of each toroid section being spaced a distance, a, from the rotational centerline (CL) of the coupling. Each partial toroid 43 is formed of radius, b, about said toroid center. The wall thickness, t_{w} of the split toroid parts is less than the wall thickness, tₚ of the narrow annular sections.

The pipe pressure hoop loads are carried by the narrow annular sections 49, 51 in the flexible coupling. These annular sections are resistant to flex when the bellow connection is bent. Annular sections could be formed of a metal material, such as nickel or titanium or any suitable alloys, and could be additionally fiber reinforced or formed of composite materials. The flexible couplings can be configured to withstand the high fluid pressures being carried in the ducts to the rocket combustion chambers.

Bending of the flexible connection is enabled by the split toroids 43, which elastically deform. The split toroid sections 43 can be manufactured in extremely thin material due to their small internal radius. This construction means that the pressure load (pipe hoop) carrying material and the bending material have distinct separate roles, and can be formed of suitable, possibly distinct and different, materials accordingly.

The pipe axial loads are carried by an external or internal gimbal arrangement 65 coupled to the pipe walls via vanes 66a, 66b, 66c, 66d.

As an alternative to the annular rings 51, a thick walled spiral could be used instead. The spiral may carry the pipe hoop burst loads, but may have greater stiffness to carry its own weight and prevent flow induced vibrations. The partial toroids could be formed substantially the same as shown in FIG. 9.

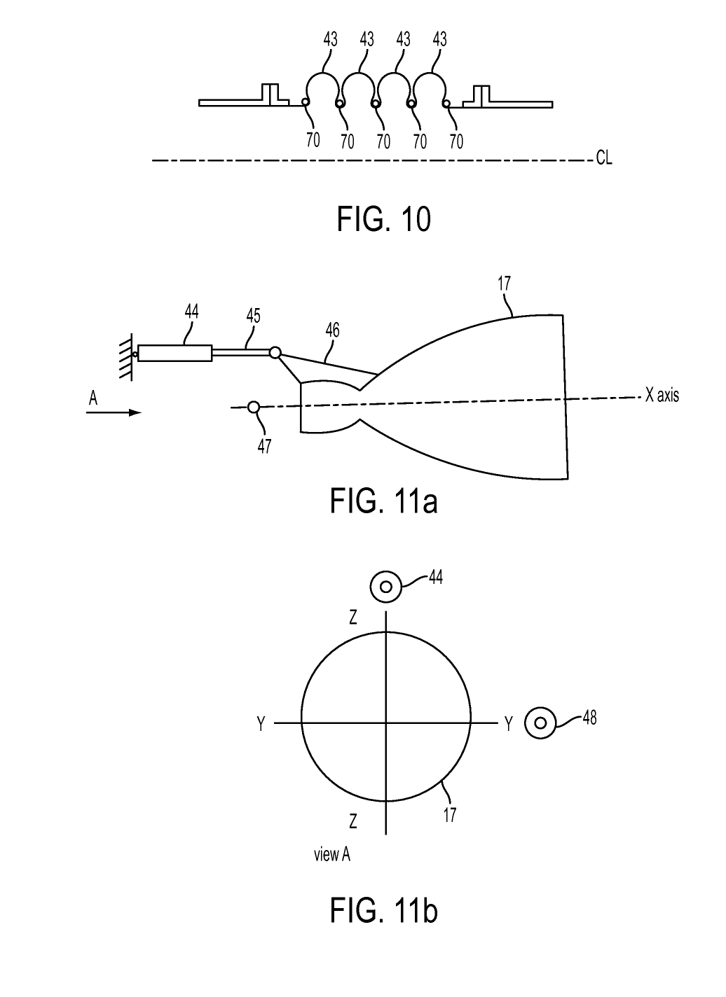

A further embodiment of a flexible coupling is shown in FIG. 10. Instead of the annular rings, round section wire 70 may be used to reinforce the coupling. The partial toroids 43, which are thin walled, may be hydroformed from a single sheet of material. This can serve to reduce the difficulty in effecting a pressure-tight join with the annular rings as shown in FIG. 9.

FIG. 11a shows a schematic representation of a rocket nozzle 17 and actuator 44 which includes actuator piston 45. The actuator may be provided as a hydraulic, electric or electro-hydraulic unit that can be used to vary the degree of movement of the rocket nozzle about the gimbal point 47, which lies on the gimbal plane 36 as shown in FIGS. 3a to 5b.

The gimbal point 47 is a point about which the rocket nozzle 17 may pivot. The actuator 44 is connected via the piston 45 to a mounting 46 which is used to support the nozzle 17.

In the example, each nozzle is provided with two actuators, acting parallel to the rocket chamber axis, but positioned orthogonally to one another. This gives rotation about both Y and Z axes as shown in FIG. 11b. As shown in FIG. 11b, a first actuator is shown in line with axis ZZ and second actuator 48 is provided in line with axis YY.

The arrangement of ducts and flexible connections can provide for a compact design of the mounting assembly and can facilitate the movement of the rocket nozzles in order to control the trajectory of a rocket powered vehicle.

Various modifications may be made to the described embodiments without departing from the scope of the invention as defined in the accompanying claims.

1. A mounting assembly for mounting a rocket nozzle to allow the nozzle to pivot about a pivot or gimbal point, the assembly comprising:
a fluid duct for supply of fluid to the nozzle, the duct comprising two or more flexible fluid couplings which substantially intersect a common plane on which the pivot point is arranged.

2. A mounting assembly as claimed in claim 1, wherein the flexible couplings intersect the common plane by being arranged substantially on, orientated in line with, crossing, or traversing the common plane.

3. A mounting assembly as claimed in claim 1, wherein the flexible couplings traverse the common plane orthogonally to the surface of the common plane.

4. A mounting assembly as claimed in claim 1, wherein the mounting assembly is configured as a rocket nozzle mounting assembly.

5. A mounting assembly as claimed in claim 1, wherein the fluid ducts are formed of substantially rigid materials.

6. A mounting assembly as claimed in claim 1, wherein at least sections of the internal flow passages or longitudinal axes of the flexible couplings are on, aligned with, or perpendicular to the common plane.

7. A mounting assembly as claimed in claim 1, wherein at least one consecutive pair of the flexible fluid couplings of the fluid duct are arranged or positioned generally orthogonal to one another about a central axis passing through the pivot point.

8. A mounting assembly as claimed in claim 1, wherein a duct between a consecutive pair of flexible couplings is aligned in or parallel to the common plane.

9. A mounting assembly as claimed in claim 1, comprising additional ducts, wherein two, three, or more flexible couplings are spaced or offset from the common plane.

10. A mounting assembly as claimed in claim 1, comprising a further fluid duct which comprises a flexible fluid coupling arranged on or traversing the common plane and in line with the pivot point.

11. A mounting assembly as claimed in claim 1, wherein the flexible couplings are configured as bellow-like connections.

12. A mounting assembly as claimed in claim 1, wherein the flexible couplings comprise an external or internal gimbal arrangement.

13. A mounting assembly as claimed in claim 1, wherein the mounting assembly further comprises a mounting for a rocket nozzle, the mounting being gimbaled or pivotally coupled to allow rotation of the mounting about orthogonal axes on the common plane.

14. A mounting assembly as claimed in claim 13, wherein the mounting for the rocket nozzle is configured to permit angular adjustment of the nozzle by up to −/+5 degrees or +/−3 degrees relative to a gimbal axis.

15. A mounting assembly as claimed in claim 13, wherein said mounting assembly further comprises one or more actuators for effecting rotation of the mounting about the orthogonal axes.

16. A mounting assembly as claimed in claim 1, wherein said mounting assembly further comprises a rocket nozzle supported on said mounting, the rocket nozzle having its central longitudinal axis substantially concentric with the pivot point.

17. A rocket engine module comprising a plurality of mounting assemblies according to claim 1.

18. A rocket engine module according to claim 17, wherein the rocket engine module comprises an air breathing rocket combustion chamber and an air-breathing combustion chamber.

19. A flexible coupling, comprising a plurality of spaced annular elements, wherein a partial toroid element connects consecutive pairs of annular elements.

20. A flexible coupling according to claim 19, wherein the annular elements comprise annular rings.

21. A flexible coupling as claimed in claim 19, wherein the annular elements comprise round or rounded section wire.

22. A flexible coupling as claimed in claim 19, wherein the annular elements comprise a spiral wall element.

23. A flexible coupling as claimed in claim 19, wherein each partial toroid element is part of a single sheet of material.

24. A flexible coupling as claimed in claim 19, wherein the coupling comprises a metallic material.

25. A flexible coupling as claimed in claim 19, wherein the coupling comprises fiber reinforcement.

26. A mounting assembly for mounting a rocket nozzle to allow the nozzle to pivot about a pivot or gimbal point, the assembly comprising a fluid duct for supply of fluid to said nozzle, the duct comprising a flexible fluid coupling arranged on the pivot point and/or traversing a common plane in line with said pivot point.

27. A mounting assembly as claimed in claim 26, wherein the flexible coupling is in line with a gimbal or pivot axis which passes through said gimbal point and relative to which the rocket nozzle can be angled.
